(19) United States
(12) Patent Application Publication
(10) Pub. No.: US 2010/0017227 A1
(43) Pub. Date: Jan. 21, 2010

(54) Method, System and Related Software for Collecting and Sharing Patient Information

(76) Inventor: Raul Kivatinetz, Los Angeles, CA (US)

Correspondence Address: BUCHALTER NEMER, 18400 VON KARMAN AVE., SUITE 800, IRVINE, CA, 92612, US

(21) Appl. No.: 12/301,516

(22) PCT Filed: May 22, 2007
(86) PCT No.: PCT/US07/12153

§ 371 Date: May 14, 2009

Related U.S. Application Data
(60) Provisional application No. 60/802,887, filed on May 22, 2006.

(51) Int. Cl. G06Q 50/00; G06F 17/30

(52) U.S. Cl. 705/3; 707/104.1

(57) ABSTRACT

Methods of creating, distributing and/or accessing patent information are described herein that include: a) preparing at least one doctor input information dataset, b) utilizing at least one processing technique to process the at least one dataset to form an updated patient scenario, c) translating the scenario into a suitable protocol or index, and d) storing the scenario. Systems that create, distribute and/or access patient information are also described herein that include: a) a computer, b) a user interface, and c) software designed to prepare at least one doctor input information dataset, utilize at least one processing technique to process the at least one dataset to form an updated patient scenario, translate the scenario into a suitable protocol or index, and store the scenario. Methods of creating patient information is also disclosed that include: a) identifying a patient, b) retrieving a scenario related to the patient, a medical condition, or a combination thereof, c) preparing at least one doctor input information dataset, d) utilizing at least one processing technique to process the at least one dataset to form an updated patient scenario, an updated medical condition scenario or a combination thereof, e) translating the scenario into a suitable protocol or index, and f) storing the scenario.

This application is a national stage application based on PCT Application Serial No.: PCT/US07/12153 filed on May 22, 2007, which is based on U.S. Provisional Application Ser. No. 60/802,887 filed on May 22, 2006, which are commonly owned and incorporated herein in their entirety by reference.

### FIELD OF THE SUBJECT MATTER

The subject matter disclosed herein relates to computerized and/or automated healthcare clinical scenarios, status or collection of patient information using natural language processing techniques for the reduction of task redundancies in patient documentation for doctors and other health care professionals.

### BACKGROUND

Physicians and other medical providers document their clinical encounters with patients in narrative format for most part. As a general rule the documentation is unstructured; however, the physicians follow a semi-structured methodology (i.e., Subjective, Objective, Assessment, Plan). Most physicians conform to their own style of documentation for each type of assessment made when they encounter the patient. This assessment is made by the physician after examining the patient and coming up with differential diagnoses but also taking into consideration multiple factors such as socio-economics, availability of resources for treatment, etc. However, for different patients with similar assessment the documentation presents small variability and a high degree of repetition.

Therefore, there is a need in the medical field to provide a patient information documentation system in the form of computerized and/or automated health care clinical “scenarios” or collections of information using natural language processing techniques, so that redundancies in such documentation are reduced for doctors. By reducing redundancy in documenting patient conditions and treatment, doctors can focus their time on the delivery on medical/therapeutic services and less on documentation.

### SUMMARY OF THE SUBJECT MATTER

Methods of creating, distributing and/or accessing patent information are described herein that include: a) preparing at least one doctor input information dataset, b) utilizing at least one processing technique to process the at least one dataset to form an updated patient scenario, c) translating the scenario into a suitable protocol or index, and d) storing the scenario.

Systems that create, distribute and/or access patient information are also described herein that include: a) a computer, b) a user interface, and c) software designed to prepare at least one doctor input information dataset, utilize at least one processing technique to process the at least one dataset to form an updated patient scenario, translate the scenario into a suitable protocol or index, and store the scenario.

Methods of creating patient information is also disclosed that include: a) identifying a patient, b) retrieving a scenario related to the patient, a medical condition, or a combination thereof, c) preparing at least one doctor input information dataset, d) utilizing at least one processing technique to process the at least one dataset to form an updated patient scenario, an updated medical condition scenario or a combination thereof, e) translating the scenario into a suitable protocol or index, and f) storing the scenario.

### BRIEF DESCRIPTION OF THE FIGURES

FIG. 1 is a block diagram showing some contemplated aspects of the present system where any number of doctors can create or select, transcribe, store, and access their scenarios, client information and related data. Such scenarios are then subject to natural language or processing and translated into currently known or later-developed information protocols.

FIG. 2A shows a doctor dictating elements of a new scenario and a contemplated web interface presentation.

FIG. 2B shows a recall and edit of an existing scenario in a contemplated embodiment.

### DETAILED DESCRIPTION

Surprisingly, a patient information documentation system has been developed and will be described herein in the form of computerized and/or automated health care clinical “scenarios”, templates or collections of information using natural language processing techniques, so that redundancies in such documentation are reduced for doctors. By reducing redundancy in documenting patient conditions and treatment, doctors can focus their time on the delivery on medical/therapeutic services and less on documentation.

Methods of creating, distributing and/or accessing patent information are described herein that include: a) preparing at least one doctor input information dataset, b) utilizing at least one processing technique to process the at least one dataset to form an updated patient scenario, c) translating the scenario into a suitable protocol or index, and d) storing the scenario. A software code that is designed to execute the above-referenced method and its various embodiments is also contemplated.

Systems that create, distribute and/or access patient information are also described herein that include: a) a computer, b) a user interface, and c) software designed to prepare at least one doctor input information dataset, utilize at least one processing technique to process the at least one dataset to form an updated patient scenario, translate the scenario into a suitable protocol or index, and store the scenario.

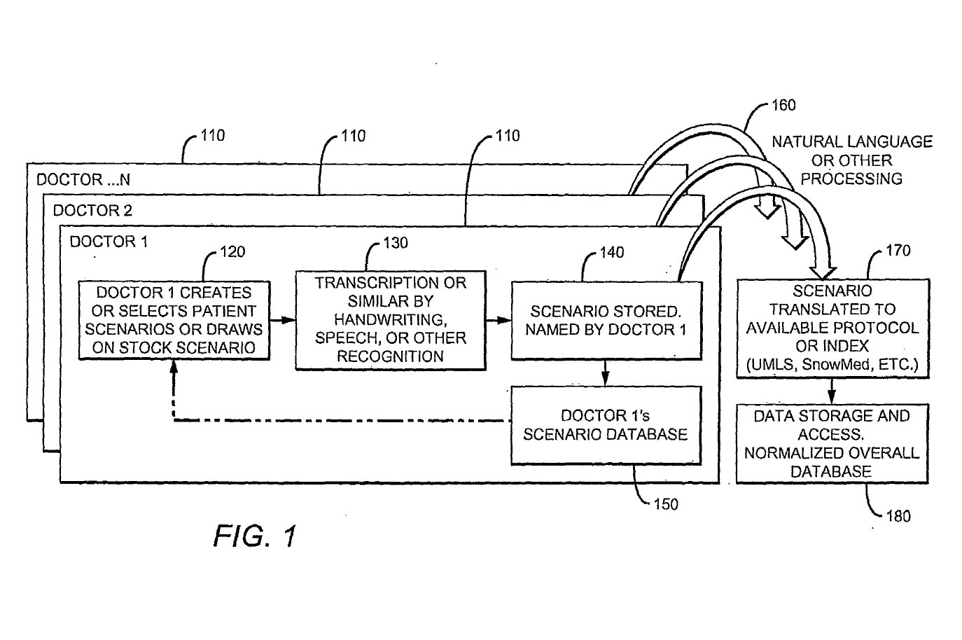

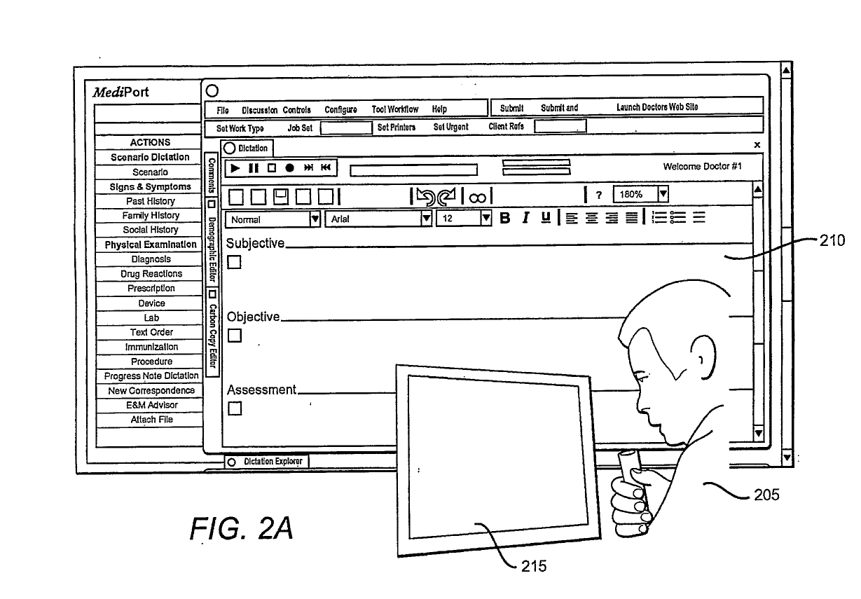

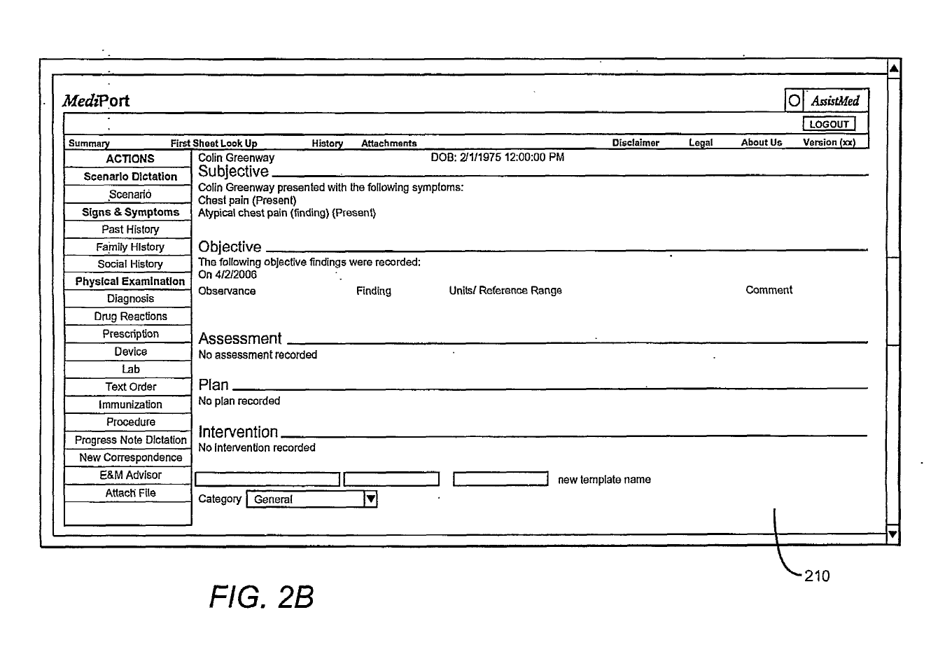

In reference to the drawings, a flow chart shown in FIG. 1 showing process, scalability and transportability of the system and information generated by this system, while FIGS. 2A and 2B shows a contemplated display (210) based upon the information generated by a filled in scenario. In FIG. 2A, a doctor (205) is shown entering data via voice recognition into the system (not shown) on a laptop computer (215).

Generally, the doctor creates or selects one or more scenarios or templates that applies to the patient's medical condition(s), filling in the pertinent information. These scenarios then are transcribed into electronic form manually by transcriptionists or by recognition system that may recognize handwriting, speech, and/or other forms of expression. The scenario is stored on an electronic or other information storage means and is named by the doctor. The scenarios stored in or available to the Scenario database of the first doctor who may use it and document other patients clinical encounters. As shown in FIG. 1, at least one doctor input information datasets (110) is collected, processed by utilizing a natural language or another processing technique (160), the scenario is translated to available protocol or index (170), and then the data is stored and is available for access (180). The at least one doctor input information dataset (110) can be produced by the same doctor on different days or different doctors on the same or different days. In FIG. 1, the doctor input information dataset (110) comprises: a) the doctor creates or selects a scenario or utilizes a stock or standard scenario (120), b) the information is transcribed or written down by any suitable method, such as handwriting, speech or other recognition (130), c) the scenario is approved, named and stored by the doctor (140), and d) a condition “scenario” is created (150) that can be accessed by that doctor at a later time and/or date. The doctor has the option to make the scenario available to other doctors by saving a copy on the Global Scenario database (190)

When the scenario is stored by the doctor, the scenario may then be translated by natural language or other processing. Such natural language or other processing may translate medical normalized terms to ones that are more familiar (e.g. “hypertension” to “high blood pressure”) or vice versa. Once the scenario has undergone natural language or other processing, it will then be translated and mapped into standard protocols, formats and/or indeces such as those known in the art, including UMLS, SNOMED, HL7-CDA, CCD, CPT, ICOD-9, ICD-10, etc. The scenario is then stored and may be made available in a normalized overall database, other database, or other data configuration in order to make it available not only to the doctors locally associated with the first doctor, but throughout a network or even world wide as by the Internet, As shown in FIG. 1, any number of doctors to create their own scenarios which are then available to them, their fellow colleagues or, when subject to natural language or other processing, available to the medical community or other authorized users as a whole.

The system and methods described herein are designed to reside in an encrypted by accessible system, thereby reducing medical practitioner, particularly doctor, documentation repetition for patients having similar conditions, treatment regimes, or the like. As shown in the drawings, a doctor may create or select a scenario. The doctor then articulates the patient's history, condition, status, prognosis, etc. in order to document the patient's condition. In doing so, if a scenario is already available, descriptive portion of the patient's condition can be copied into the new scenario for use for the doctor and editing and alteration to tailor it specifically to the current patient. Once complete, the scenario is then transcribed into electronic or other readily available or useful information storage types, such as electronic data format. The scenario may be then stored and named by Doctor 1 (FIG. 1), the scenario then being stored in Doctor 1's database. The same process may go on for Doctor 2, Doctor 3, . . . Doctor n as indicated in FIG. 1.

In the scenario stored and named, it may be automatically or otherwise subject to natural language or other processing. The natural language process helps index the scenario created by the doctor into a currently-available or known standard nomenclature or one that is otherwise developed in the future. Currently known protocols include those under the names of UMLS, SNOMED, HL7-CDA, CCD, CPT, ICD-9, ICD-10, and others. Once indexed into an established protocol, the scenario can then be stored and made available for access in a normalized overall database, other database, or other catalogue of information.

In FIG. 1, the transcription step may result in free text or XML-parsed text, which is then stored with the name selected by Doctor 1, for example. This tree text or XML-parsed text may also then be subject to natural language processing, wherein phrases such as “high blood pressure” may be standardized to a term such as “hypertension,” vice versa, or otherwise in order to provide some means by which to better assimilate, categorize, recognize, and manipulate/mind the resulting data from the doctor's scenario.

Referring to the drawings, it will be noted that contemplated embodiments help to free doctors from routine patient documentation tasks, especially ones that are repetitive. In order to facilitate clinical documentation in healthcare encounters the proposed system includes the following steps: scenario creation or selection; scenario editing, scenario transcription-indexing; scenario naming; and scenario saving/archiving. The scenario is made available for later editing and use.

In addition, considering the fact that over time each doctor may create hundreds of scenarios, which may be difficult to remember and retrieve, the process includes a powerful and logical methodology to easily locate the closest scenario(s) that applies to the condition of the patient that is being evaluated by the doctor.

This “navigation and location” process or method includes maintaining a hierarchical database with the statistics of the use of each scenario cross-indexed to the normalized terminology that was mapped by the Natural Language Processing. Therefore, when the doctor is looking for a particular scenario he can just search for a term or series of terms that may be contained in it, i.e. search for “increased blood pressure” will bring the list of all the scenarios that contain not only these terms but all the ones that contain the same concept (as mapped during the normalization process) such as “high blood pressure”, “hypertension”, “BP=130/95”, etc. The scenarios will be presented to the doctor following a frequency distribution algorithm with the one that had the highest usage at the top of the list. Furthermore, the is system provides filters so the doctor may narrow the search to just include scenarios that include the term (concept) in a particular subsection, i.e. “Tylenol” in the “Plan” or “Prescription” section.

The process also allows the doctor to broaden the search to find scenarios or templates created by other doctors and stored in a “Global Scenario Database”. This database and overall process is particularly useful when the doctor just start using the system, because it allows him/her to re-cycle scenarios created by his/her colleagues or institutions, speeding up the creation of his personal library of scenarios. Specifically, methods of creating patient information have been disclosed that include: a) identifying a patient, b) retrieving a scenario related to the patient, a medical condition, or a combination thereof, c) preparing at least one doctor input information dataset, d) utilizing at least one processing technique to process the at least one dataset to form an updated patient scenario, an updated medical condition scenario or a combination thereof, e) translating the scenario into a suitable protocol or index, and f) storing the scenario.

### EXAMPLE

### Scenario Creation

Present the physician with a guideline of categories for dictation scenarios. This guideline will vary based on class of encounter (i.e., first time consultation, follow-up, industrial injury, age and gender group, specialty, payor, etc.). The guideline can be incorporated in digital forms with audio tags that can be rendered via computer, portable devices or telephony systems.

The physician dictates the scenario(s) following the guideline(s) for each class of encounter.

The dictation is transcribed by computer or human speech recognition or combination of both producing a free text or xml parsed text.

The free or xml parsed text is indexed using Natural Language Processing.

The resulting index is cross-referenced and mapped to standard nomenclature(s).

### Documentation Using Scenarios:

The nurse uses a scenario to gather chief complaint, history and vital signs.

The physician reviews the documentation done by the nurse and after questioning the patient he selects a scenario for the closest case based on his assessment of the patients condition The scenario populates most of the documentation needed for this assessment. The physician dictates, types or handwrites (using hand-writing recognition software) the elements not contained in the case.

The physician then just selects to save this note as a one-time scenario or also create a differential scenario.

The documentation is completed.

### Sample Transcription

A sample transcription of a dictation for a scenario of heel pain complaint is shown:

### History of Present Illness:

This is a 55-year-old white female who presented with chief complaint of right heel pain on arising in the morning and trying to take the first few steps. She has had this for several months. She has been treated conservatively with ibuprofen. She's tried rest, exercises, and also ice and none of these treatments provided relief.

### Allergies:

Patient is not allergic to any medication.

### Past Medical History:

She has a history of flat feet. Otherwise negative.

### Family History:

Negative for TB or diabetes mellitus.

### Social History:

She doesn't smoke she doesn't drink alcoholic beverages. She works as a department store clerk and is on her feet approximately 8 hours/day on a concrete floor. She's married.

### Review of Systems:

### Negative.

### Physical Examination:

VITAL SIGNS: She weighs 200 lbs. She's 5 foot 3 inches. Respirations are 12, pulse is 92, blood pressure 140/90, temperature is 98.2.
Examination reveals tenderness over the right heel to palpation at the insertion of the plantar fascia. X-ray was obtained of the right foot and heel and these were read as negative. Examination also reveals flat feet.

### Treatment:

It was decided to inject the heel with 40 mg of Depo-Medrol, via the plantar approach.

### Diagnosis:

Plantar fasciitis and pes planus.

### Plan:

Also a podiatry consult will be obtained.

### What Follows is a Sample of the Resulting Natural Language Processing or “NLP”:

- <document>
<section c=“report unknown section item”>
<structured form= “indented”>problem: pain bodyloc>> heel idref>> 10 code>>
UMLS:C0018870_heel idref>> [10] idref>> 12 parsemode>> mode5 sectname>>
report unknown section item sid>> 1 code>> UMLS:C0231780_heel pain idref>>
[10,12] </structured>
- <tt>
-<sent id=“s1”>
This a
<undef>scenario</undef>
for
<phr id=“p10”>heel</phr>
<phr id=“p12”>pain</phr>
.
</sent>
</tt>
.
</section>
- <section c=“report history of present illness item”>
<structured form= “indented”>finding:demo age>> [55,[idref,25],year,[idref,27]]
parsemode>> model race>> white idref>> 31 sectname>> report history of
present illness item sex>> female idref>> 33 sid>> 2 problem:pain bodyloc>>
heel idref>> 49 region>> right idref>> 47 code>> UMLS:C0817704_right heel
idref>> [47,49] idref>> 51 parsemode>> mode3 sectname>> report history of
present illness item sid>> 2 status>> chief complaint idref>> 41 timeper>>
presentation idref>> 37 code>> UMLS:C0231780_heel pain idref>> [49,51]
med:ibuprofen idref>> 111 parsemode>> model sectname>> report history of
present illness item sid>> 4 code>> UMLS:00020740_ibuprofen idref>> [111]
procedure:physical therapy exercises idref>> 125 parsemode>> model
sectname>> report history of present illness item sid>> 5 code>>
UMLS:C0452240_physical therapy exercises idref>> [125] procedure:
procedure - therapeutic certainty>> no idref>> 136 idref>> 142 parsemode>>
mode 2 sectname>> report history of present illness item sid>> 5 code>>
UMLS:C0749657_treatment refused idref>> [136,142] problem:better idref>>
146 parsemode>> model sectname>> report history of present illness item
sid>> 5</structured>
- <tt>
<p />
HISTORY OF PRESENT ILLNESS:
- <sent id=“s2”>
This is a
<phr id=“p25”>55-year-old</phr>
<phr id=“p31”>white</phr>
<phr id=“p33”>female</phr>
who
<phr id=“p37”>presented with</phr>
<phr id=“p41”>chief complaint of</phr>
<phr id=“p47”>right</phr>
<phr id=“p49”>heel</phr>
<phr id=“p51”>pain</phr>
on arising in the morning and
<undef>trying</undef>
to take the first few
<undef>steps</undef>
.
</sent>
<sent id=“s3”>She has had this for several months.</sent>
- <sent id=“s4”>
She has been treated conservatively with
<phr id=“p111”>ibuprofen</phr>
.
</sent>
- <sent id=“s5”>
She
<undef>’</undef>
s
<undef>tried</undef>
<undef>rest</undef>
’
<phr id =“p125”>exercises</phr>
’and also
<undef>ice</undef>
and
<phr id=“p136”>none of</phr>
these
<phr id=“p142”>treatments</phr>
provided
<phr id=“p146”>relief</phr>
.
</sent>
</tt>
</section >
- <section c=“report allergy item”>
<structured form= “indented”>med: medication certainty>> high certainty idref>>
156 idref>> 166 parsemode>> model reaction>> allergy idref>> 160 neg>> no
idref>> 158 sectname>> report allergy item sid>> 6 code>>
UMLS:C0013227_pharmaceutical preparations idref>> [166] </structured>
- <tt>
<p />
ALLERGIES:
- <sent id=“s6”>
Patient
<phr id=“p156”>is</phr>
<phr id=“p158”>not</phr>
<phr id=“p160”>allergic to</phr>
any
<phr id=“p166”>medication</phr>
.
</sent>
</tt>
</section > <section c=“report past history item”>
<structured form= “indented”>finding:flattened bodyloc>> foot idref>> 184
code>> UMLS:C1281587_entire foot idref>>.[184] certainty>> high certainty
idref>> 174 idref>> 182 parsemode>> model sectname>> report past history
item sid>> 7 status>> history idref>> 178 code>> UMLS:C0016202_flatfoot
idref>> [182,184] </structured >
- <tt>
<p />
PAST MEDICAL HISTORY:
- <sent id=“s7”>
She
<phr id=“p174”>has</phr>
a
<phr id=“p178”>history of</phr>
<phr id=“p182”>flat</phr>
<phr id=“p184”>feet</phr>
.
</sent>
<sent id=“s8”>Otherwise negative. </sent>
</tt>
</section>
- <section c=“report family history item”>
<structured form= “indented”>problem:tuberculosis certainty>> negative
idref.>> 197 idref>> 201 parsemode>> model sectname>> report family history
item sid>> 9 code>> UMLS:C0041296_tuberculosis idref>> [201]
problem:diabetes mellitus certainty>> negative idref>> 197 idref>> 205
parsemode>> model 1 sectname>> report family history item sid>> 9 code>>
UMLS:C0011849_diabetes mellitus idref>> [205] </structured>
- <tt>
<p />
FAMILY HISTORY:
- <sent id=“s9”>
<phr id=“p197”>negative for</phr>
<phr id=“p201”>TB</phr>
or
<phr id=“p205”>diabetes mellitus</phr>
.
</sent>
</tt>
</section>
<section c=“report social history item”>
<structured form= “indented”>problem:smokes idref>>.220 parsemode>> mode4
sectname>> report social history item sid>> 10 code>>
UMLS:C0037369_smoking idref>> [220] problem:drink idref>> 228
parsemode>> mode5 sectname>> report social history item sid>> 10 code>>
UMLS:C0556317_drinks alone idref>> [228] </structured>
- <tt>
<p />
SOCIAL HISTORY:
- <sent id=“s10”>
she
<undef>doesn</undef>
<undef>’</undef>
<undef>t</undef>
<phr id=“p220”>smoke</phr>
she
<undef>doesn</undef>
<undef>’</undef>
<undef>t</undef>
<phr id=“p228”>drink</phr>
alcoholic
<undef>beverages</undef>
.
</sent>
- <sent id=“s11”>
She
<undef>works</undef>
as a
<undef>department</undef>
<undef>store</undef>
<undef>clerk</undef>
and is on her feet approximately 8 hours/day on a
<undef>concrete</undef>
floor. </sent>
- <sent id=“s12”>
She
<undef>’</undef>
s
<undef>married</undef>
.
</sent>
</tt>
</section >
<section c=“report review of systems item”>
- <tt>
<p />
REVIEW OF SYSTEMS:
<sent id=“s13”>Negative.</sent>
</tt>
</section >
- <section c=“report physical examination item”>
<structured form= “indented”>bodymeas:vital signs idref>>296 parsemode>>
mode1 sectname>> report physical examination item sid>> 14 code>>
UMLS:C0518766 vital sign idref>> [296] bodymeas:weight certainty>> high
certainty idref>> 304 measure>> [200,[idref,306],lbs,[idref,308]] parsemode>>
mode1 sectname>> report physical examination item sid>> 14
bodymeas:respiration certainty>> high certainty idref>> 328 idref>> 326
measure>> [12,[idref,330]] parsemode>> mode 1 sectname>> report physical
examination item sid>> 16 code>> UMLS:C0035203_respiration idref>> [326]
bodymeas:pulse rate certainty>> high certainty idref>> 335 idref>> 333
measure>> [92,[idref,337]] parsemode>> model sectname>> report physical
examination item sid>> 16 code>> UMLS:C0391850_physiologic pulse idref>>
[333] bodymeas:blood pressure idref>> 340 measure>>
[140,[idref,344],90,[idref,346]] parsemode>> mode1 sectname>> report physical
examination item sid>> 16 code>> UMLS:00005823 blood-pressure 45 idref>>
[340] bodymeas:temperature certainty>> high certainty idref>> 351 idref>> 349
measure>> [98.2,[idref,353]] parsemode>> model sectname>> report physical
examination item sid>> 16 code>> UMLS:C0679032 temperature perception
idref>> [349] procedure:examination idref>> 359 parsemode>> model
sectname>> report physical examination item sid>> 17 50 problem:tenderness
bodyloc>> heel idref>> 371 region>> right idref>> 369 locative>> over idref>>
365 code>> UMLS:C0817704_right heel idref>> [369,371] idref>> 363
parsemode>> mode3 sectname>> report physical examination item sid>> 17
code>> UMLS:C0239933_heel tenderness idref>> [363,371] procedure:
palpation idref>> 375 parsemode>> mode5 sectname>> report physical
examination item sid>> 17 code>> UMLS:C0030247_palpation idref>> [375]
procedure:x-ray bodyloc>> foot idref>> 408 region>> right idref>> 406 code>>
UMLS:C0230460 structure of right foot idref>> [406,408] code>>
UMLS:C1279998_entire right foot idref>> [406,408] certainty>> high certainty
idref>> 398 idref>> 394 parsemode>> model sectname>> report physical
examination item sid>> 18 code>> UMLS:C0203287 radiography of foot idref>>
[394,408] procedure:examination idref>> 430 parsemode>> mode1
sectname>>report physical examination item sid>> 19 finding:flattened
bodyloc>> foot idref>> 438 code>> UMLS:C1281587 entire foot idref>> [438]
certainty>> high certainty idref>> 434 idref>> 436 parsemode>> model
sectname>> report physical examination item sid>> 19 code>>
UMLS:00016202_flatfoot idref>> [436,438] </structured>
- <tt>
<p />
PHYSICAL EXAMINATION:
- <sent id=“s14”>
<phr id=“p296”>VITAL SIGNS</phr>
:She
<phr id=“p304”>weighs</phr>
<phr id=“p306”>200 lbs</phr>
.
</sent>
- <sent id=“s15”>
She
<undef>’</undef>
s 5 foot 3 inches.
</sent>
- <sent id=“s16”>
<phr id =“p326”>Respirations</phr>
<phr id=“p328”>are</phr>
<phr id=“p330”>12</phr>
<phr id=“p331”>,</phr>
<phr id=“p333”>pulse</phr>
<phr id=“p335”>is</phr>
<phr id=“p337”>92</phr>
<phr id=“p338”>,</phr>
<phr id=“p340”>blood pressure</phr>
<phr id=“p344”>140/90</phr>
<phr id=“p347”>,</phr>
<phr id=“p349”>temperature</phr>
<phr id=“p351”>is</phr>
<phr id=“p353”>98.2</phr>
.
</sent>
- <sent id=“s17”>
<phr id =“p359”>Examination</phr>
reveals
<phr id =“p363”>tenderness</phr>
<phr id=“p365”>over</phr>
the
<phr id=“p369”>right</phr>
<phr id=“p371”>heel</phr>
to
<phr id=“p375”>palpation</phr>
at the insertion of the plantar fascia.
</sent>
- <sent id=“s18”>
<phr id=“p394”>X-ray</phr>
<phr id=“p398”>was obtained</phr>
of the
<phr id=“p406”>right</phr>
<phr id=“p408”>foot</phr>
and heel and these were
<undef>read </undef>
as negative.
</sent>
- <sent id=“s19”>
<phr id =“p430”>Examination</phr>
also
<phr id=“p434”>reveals</phr>
<phr id=“p436”>flat</phr>
<phrid=“p438”>feet</phr>
.
</sent>
</tt>
</section >
- <section c=“report treatment item”>
< structured form= “indented” > med :depo-medrol dose>>
[40,[idref,461],mg,[idref,463]] idref>> 467 parsemode>> mode2 sectname>>
report treatment item sid>> 20 code>> UMLS:COO57476_Depo-Medrol idref>>
[467] </structured >
- <tt>
<p />
TREATMENT:
- <sent id=“s20”>
It was decided to
<undef>inject</undef>
the heel with
<phr id=“p461”>40 mg</phr>
of
<phr id=“p467”>Depo-Medrol</phr>
, via the plantar approach.
</sent>
</tt>
</section >
- <section c=“report diagnosis item”>
<structured form= “indented”>problem:fasciitis bodyloc>> plantar idref>> 487
code>> UMLS:C0442036_plantar idref>> [487] idref>> 489 parsemode>> mode1
sectname>> report diagnosis item sid>> 21 code>> UMLS:C0149756_plantar
fasciitis idref>> [487,489] problem:pes planus bodyloc>> plantar idref>> 487
code>> UMLS:C0442036_plantar idref>> [487] certainty>> high certainty
idref>> 491 idref>> 493 parsemode>> mode1 sectname>> report diagnosis
item sid>> 21 code>> UMLS:C0016202 flatfoot idref>> [493] </structured>
- <tt>
<p />
DIAGNOSIS:
- <sent id=“s21”>
<phr id=“p487”>plantar</phr>
<phr id=“p489”>fasciitis</phr>
<phr id=“p491”>and</phr>
<phr id=“p493”>pes planus</phr>
.
</sent>
</tt>
</section>
-<section c=“report plan item”>
- <tt>
<P />
PLAN:
- <sent id=“s22”>
Also a
<undef>podiatry</undef>
<undef>consult</undef>
will be obtained.
</sent>
</tt>
</section >
</document>

Thus, specific embodiments, software, methods of use and applications of an patient information system have been disclosed. It should be apparent, however, to those skilled in the art that many more modifications besides those already described are possible without departing from the inventive concepts herein. The graphical interface presented to the user may vary from those graphical interfaces depicted in this subject matter without departing from the inventive concepts. The inventive subject matter, therefore, is not to be restricted except in the spirit of the disclosure herein. Moreover, in interpreting the specification, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

I claim:

1. A method of creating patent information, comprising:
preparing at least one doctor input information dataset,
utilizing at least one processing technique to process the at least one dataset to form an updated patient scenario,
translating the scenario into a suitable protocol or index, and
storing the scenario.

2. The method of claim 1, wherein the method further comprises distributing and accessing patent information.

3. The method of claim 1, wherein the at least one doctor input information dataset comprises a patient scenario, a stock scenario or a combination thereof.

4. The method of claim 3, wherein the patient scenario, the stock scenario or the combination thereof comprises patient information.

5. The method of claim 4, wherein the patient information is collected by transcribing or utilizing any suitable writing method to gather the information.

6. The method of claim 3, wherein the patient scenario is stored by a doctor, a health care professional or a combination thereof.

7. The method of claim 1, wherein utilizing at least one processing technique to
process the at least one dataset to form an updated patient scenario includes natural language processing.

8. The method of claim 1, wherein translating the scenario into a suitable protocol or index includes utilizing UMLS, SNOWMED or a combination thereof.

9. The method of claim 1, wherein storing the scenario includes utilizing any suitable storage method or device.

10. The method of claim 9, wherein the storage method or device includes portable storage media, a hard drive, a database or a combination thereof.

11. A software code that executes the method of claim 1.

12. A system that creates patient information, comprising:
a computer,
a user interface, and
software designed to prepare at least one doctor input information dataset, utilize at least one processing technique to process the at least one dataset to form an updated patient scenario, translate the scenario into a suitable protocol or index, and store the scenario.

13. A method of creating patent information, comprising:
identifying a patient,
retrieving a scenario related to the patient, a medical condition, or a combination thereof,
preparing at least one doctor input information dataset,
utilizing at least one processing technique to process the at least one dataset to form an updated patient scenario, an updated medical condition scenario or a combination thereof,
translating the scenario into a suitable protocol or index, and
storing the scenario.
